(19) United States
(12) Patent Application Publication
(10) Pub. No.: US 2021/0216732 A1
(43) Pub. Date: Jul. 15, 2021

(54) Article Management System and Method

(71) Applicant: Nippon Telegraph and Telephone Corporation, Tokyo (JP)

(72) Inventors: Toshishige Shimamura, Tokyo (JP); Yuichi Okabe, Tokyo (JP); Tsuyoshi Yamamoto, Tokyo (JP); Yuzo Ishii, Tokyo (JP)

(21) Appl. No.: 17/252,664

(22) PCT Filed: May 24, 2019
(86) PCT No.: PCT/JP2019/020663

§ 371 Date: Dec. 15, 2020

(30) Foreign Application Priority Data
Jun. 20, 2018 (JP) 2018-116773

(51) Int. Cl. G06K 7/10; G06F 3/0346

(52) U.S. Cl. CPC G06K 7/10405; G06F 3/0346

(57) ABSTRACT

When vibration of the item is detected by an acceleration sensor, each terminal mounted in advance on an item as a management target wirelessly transmits a terminal ID for identifying the terminal and terminal-side vibration data representing the vibration detection, and in response to reception of the terminal-side vibration data wirelessly transmitted from each terminal, a management device sequentially records the terminal ID received together with the terminal-side vibration data to a detection list in a storage unit and displays the terminal IDs recorded in the detection list on a screen.

### CROSS-REFERENCE TO RELATED APPLICATIONS

This patent application is a national phase entry of PCT Application No. PCT/JP2019/020663, filed May 24, 2019, which claims the priority of Japanese Application No. 2018-116773, filed Jun. 20, 2018, each of which is incorporated herein by reference in its entirety.

### TECHNICAL FIELD

The present invention relates to an item management technology of managing items based on terminal IDs transmitted from a plurality of terminals mounted in advance on the items.

### BACKGROUND

Disclosed as a conventional technology with which a user checks an item such as a brought item is an item management system in which a terminal such as an RFID tag configured to transmit a terminal ID as unique identification information is mounted in advance on an item and a management device receives the terminal ID transmitted from the terminal and checks, based on the terminal ID, the existence of the item on which the corresponding terminal is mounted (refer to Patent Literatures 1 and 2, for example).

### CITATION LIST

### Patent Literature

Patent Literature 1: Japanese Patent Laid-open No. 2013-125367

Patent Literature 2: Japanese Patent Laid-open No. 2005-309831

### SUMMARY

### Technical Problem

However, with such a conventional technology, a user needs to manually register the correspondence relation between an item and the terminal ID of a terminal to the management device in advance. In this case, when starting operation of the item management system, the user checks, for each item, the terminal ID of a terminal mounted on the item and inputs the correspondence relation between the name of the item and the terminal ID to the management device. This imposes a heavy work load on the user.

Embodiments of the present invention are intended to solve such a problem and provide an item management technology with which a user can manage items with a light work load.

### Means for Solving the Problem

To achieve the above-described intention, an item management system according to embodiments of the present invention includes: a plurality of terminals each mounted in advance on an item as a management target and each configured to wirelessly transmit a terminal ID for identifying the terminal when vibration is detected by a built-in first acceleration sensor; and a management device configured to sequentially record the terminal IDs received from the plurality of terminals to a detection list in a storage unit and display the terminal IDs recorded in the detection list on a screen.

In an exemplary configuration of the above-described item management system according to embodiments of the present invention, the plurality of terminals wirelessly transmit terminal-side vibration data in a duration in which the vibration is detected, the management device generates management-side vibration data in a duration in which vibration is detected by a built-in second acceleration sensor, and when recording each terminal ID, the management device compares a first detection duration in which vibration of the item is detected according to the terminal-side vibration data and a second detection duration in which vibration of the management device is detected according to the management-side vibration data, and determines whether recording of the terminal ID to the detection list is permitted based on the length of an overlap duration in which the first and second detection durations overlap each other or the frequency of detection of the overlap duration.

In an exemplary configuration of the above-described item management system according to embodiments of the present invention, the management device records each terminal ID to the detection list only when the terminal ID is received until a record permission duration of a certain length elapses since it is checked that the length of the overlap duration has reached a determination duration set in advance.

In an exemplary configuration of the above-described item management system according to embodiments of the present invention, when a collation instruction is input through an operation or when a beacon signal is received from a beacon terminal installed at a predetermined place, the management device collates each terminal ID in the detection list and each terminal ID in a check list stored in the storage unit and gives notification of an obtained collation result in a visible, audible, or vibrating manner.

In an exemplary configuration of the above-described item management system according to embodiments of the present invention, when collating each terminal ID in the detection list, the management device searches past detection lists stored in the storage unit for a detection list corresponding to the date and time or day of week of the detection list and selects the corresponding detection list as the check list.

In an exemplary configuration of the above-described item management system according to embodiments of the present invention, when recording each terminal ID, the management device records, in addition to the terminal ID, a reception time at which the terminal ID is received to the detection list, and when displaying each terminal ID recorded in the detection list on a screen, the management device displays the reception time together with the terminal ID on the screen.

Another item management system according to embodiments of the present invention includes: a plurality of terminals each mounted in advance on an item as a management target and each configured to wirelessly transmit a terminal ID for identifying the terminal when vibration is detected by a built-in first acceleration sensor; a higher-level device configured to sequentially record the terminal IDs received from the plurality of terminals to a detection list in a storage unit; and a management device configured to display, on a screen, the terminal IDs recorded in the detection list acquired from the higher-level device through a communication line.

In an exemplary configuration of the above-described item management system according to embodiments of the present invention, the plurality of terminals wirelessly transmit the terminal-side vibration data in a duration in which the vibration is detected, the management device wirelessly transmits management-side vibration data in a duration in which vibration of the management device is detected by a second acceleration sensor, and when recording each terminal ID, the higher-level device compares a first detection duration in which vibration of the item is detected according to the terminal-side vibration data and a second detection duration in which vibration of the management device is detected by the terminal-side vibration data, and determines whether recording of the terminal ID to the detection list is permitted based on the length of an overlap duration in which the first and second detection durations overlap each other or the frequency of detection of the overlap duration.

In an exemplary configuration of the above-described item management system according to embodiments of the present invention, the management device wirelessly transmits a collation request related to the detection list to the higher-level device in accordance with a collation instruction input through an operation and gives notification of a collation result as information provided from the higher-level device in response to the collation request in a visible, audible, or vibrating manner, and the higher-level device collates each terminal ID in the detection list and each terminal ID in a check list stored in the storage unit in response to the collation request from the management device and provides information of an obtained collation result to the management device, and when collating each terminal ID in the detection list, the higher-level device searches past detection lists stored in the storage unit for a detection list corresponding to the date and time or day of week of the detection list and generates the check list from any terminal ID, a record rate of which is a probability equal to or higher than a predetermined value among terminal IDs recorded in the obtained detection list.

In an exemplary configuration of the above-described item management system according to embodiments of the present invention, when recording each terminal ID, the higher-level device records, in addition to the terminal ID, a reception time at which the terminal ID is received to the detection list, and when displaying each terminal ID recorded in the detection list on a screen, the management device displays the reception time together with the terminal ID on the screen.

In an exemplary configuration of the above-described item management system according to embodiments of the present invention, a wireless relay device configured to accommodate the plurality of terminals and the management device through wireless lines and relay-connect the plurality of terminals and the management device to the higher-level device is further included; the wireless relay device measures a standard time synchronized with a time management server, and when relay-forwarding the terminal IDs wirelessly transmitted from the plurality of terminals to the higher-level device, the wireless relay device notifies the higher-level device of the standard time at the relay-forwarding as the reception times of the terminal IDs; and when recording each terminal ID, the higher-level device records the reception time of the terminal ID notified by the wireless relay device to the detection list in addition to the terminal ID.

In an exemplary configuration of the above-described item management system according to embodiments of the present invention, the wireless relay device includes a parent device and a child device connected with each other through a wireless relay line, the child device accommodates the plurality of terminals or the management device and relay-connects the plurality of terminals or the management device to the parent device through the wireless lines, and the parent device relay-connects, to the higher-level device, the plurality of terminals or the management device relay-connected through the child device, and when notifying the higher-level device of the reception times, the parent device corrects the reception times based on a delay time through the wireless relay line, which is obtained through measurement in advance, and then notifies the higher-level device of the corrected reception times.

An item management method according to embodiments of the present invention is used by an item management system in which a management device manages items based on terminal IDs transmitted from a plurality of terminals mounted in advance on the items, and includes: a step in which the plurality of terminals each wirelessly transmit a terminal ID for identifying the terminal when vibration is detected by a built-in first acceleration sensor; and a step in which the management device sequentially records the terminal IDs received from the plurality of terminals to a detection list in a storage unit and displays the terminal IDs recorded in the detection list on a screen.

Another item management method according to embodiments of the present invention is used by an item management system in which a higher-level device manages items based on terminal IDs transmitted from a plurality of terminals mounted in advance on the items and provides information to a management device, and includes: a step in which the plurality of terminals each wirelessly transmit a terminal ID for identifying the terminal when vibration is detected by a built-in first acceleration sensor; a step in which the higher-level device sequentially records the terminal IDs received from the plurality of terminals to a detection list in a storage unit; and a step in which the management device displays, on a screen, the terminal IDs recorded in the detection list acquired from the higher-level device through a communication line.

### Effects of Embodiments of the Invention

According to embodiments of the present invention, the terminal ID of an item is displayed on a screen at a management device when vibration is provided to the item. Thus, a user can check, for example, each brought item in a bag based on the terminal ID of the brought item. Moreover, the user can provide vibration to an item by, for example, lifting each item and check in advance a terminal ID displayed on a screen at the management device. This saves work of registering the correspondence relation between an item and the terminal ID of a terminal to a smartphone and allows the user to manage the item with a light work load.

### BRIEF DESCRIPTION OF THE DRAWINGS

FIG. 1 is a block diagram illustrating the configuration of an item management system according to a first embodiment.

FIG. 2 illustrates an exemplary configuration of a detection list.

FIG. 3 is a sequence diagram illustrating an item management operation according to the first embodiment.

FIG. 4 illustrates an exemplary brought-item notification operation at departure.

FIG. 5 is a block diagram illustrating the configuration of an item management system according to a second embodiment.

FIG. 6 is a signal waveform diagram illustrating the relation between acceleration data and vibration data.

FIG. 7 is a signal waveform diagram illustrating an exemplary comparison between terminal-side and management-side vibration data.

FIG. 8 is a signal waveform diagram illustrating an exemplary comparison (counter) between the terminal-side and management-side vibration data.

FIG. 9 is a block diagram illustrating the configuration of an item management system according to a third embodiment.

FIG. 10 is a sequence diagram illustrating an item management operation according to the third embodiment.

FIG. 11 illustrates an exemplary screen display of a brought item list.

FIG. 12 is a block diagram illustrating the configuration of an item management system according to a fourth embodiment.

FIG. 13 is a sequence diagram illustrating an item management operation according to the fourth embodiment.

### DETAILED DESCRIPTION OF ILLUSTRATIVE EMBODIMENTS

Embodiments of the present invention will be described below with reference to the accompanying drawings.

### First Embodiment

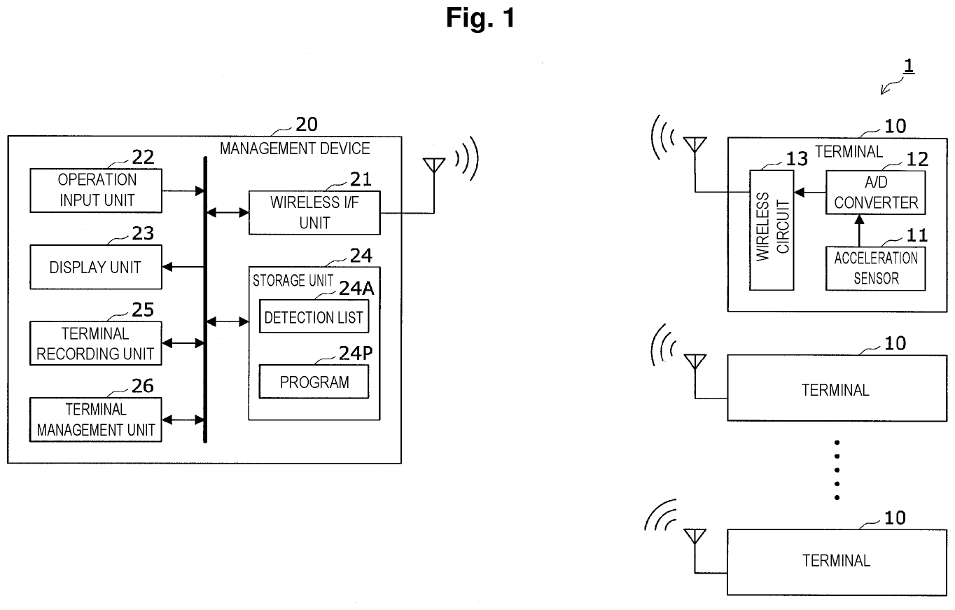

The following first describes an item management system 1 according to a first embodiment of the present invention with reference to FIG. 1. FIG. 1 is a block diagram illustrating the configuration of the item management system according to the first embodiment.

The item management system 1 includes a plurality of terminals 10 each mounted in advance on an item as a management target and each configured to wirelessly transmit a unique terminal ID, and a management device 20 configured to manage the items based on the terminal IDs wirelessly transmitted from the terminals 10.

Specific examples of the item management system 1 include a brought-item notification system configured to check a brought item that is brought by a user when the user departs and give notification, and a forgotten-item notification system configured to check whether the user brings a brought item to be brought by the user. The following description will be made on an example in which the item management system 1 is used as the above-described brought-item notification system or forgotten-item notification system.

### [Terminal]

The configuration of each terminal 10 will be first described below in detail with reference to FIG. 1.

Each terminal 10 is mainly achieved by a small-sized wireless terminal configured to perform wireless communication based on a short-distance wireless communication standard such as Bluetooth Low Energy (BLE; Bluetooth is a registered trademark). The terminal 10 is a wireless tag or an RFID tag as a specific example. As illustrated in FIG. 1, the terminal 10 includes, as main circuit units, an acceleration sensor 11, an A/D converter 12, and a wireless circuit 13.

The acceleration sensor 11 (first acceleration sensor) has a function to detect vibration of an item on which the terminal 10 is mounted and output an acceleration signal.

The A/D converter 12 has a function to perform A/D conversion of the acceleration signal from the acceleration sensor 11 into acceleration data and output the acceleration data.

The wireless circuit 13 has a function to detect vibration of the item based on the acceleration data from the A/D converter 12, a function configured to wirelessly transmit terminal-side vibration data in response to the vibration detection, and a function to wirelessly transmit, when transmitting the terminal-side vibration data, the terminal ID set in advance for identifying the terminal. The terminal ID may be transmitted as the terminal-side vibration data.

### [Management Device]

Subsequently, the management device 20 will be described below in detail with reference to FIG. 1.

The management device 20 is mainly achieved by an information processing terminal such as a smartphone, a tablet, or a cellular phone. As illustrated in FIG. 1, the management device 20 includes, as main functional components, a wireless I/F unit 21, an operation input unit 22, a display unit 23, a storage unit 24, a terminal recording unit 25, and a terminal management unit 26, and is connected to perform data forwarding through an internal bus. Among these functional components, the terminal recording unit 25 and the terminal management unit 26 are achieved through cooperation of a CPU (not illustrated) with a program 24P in the storage unit 24.

The wireless I/F unit 21 has a function to perform data communication with the terminals 10 based on a short-distance wireless communication standard such as BLE.

The operation input unit 22 is achieved by an operation input device such as a touch panel or an operation button and has a function to detect a user operation.

The display unit 23 includes a screen display device such as an LCD and has a function to perform screen display of various kinds of information such as a detection list to be described later.

The storage unit 24 is achieved by a storage device such as a semiconductor memory and has a function to store processing data used for item management processing at the management device 20 and the program 24P.

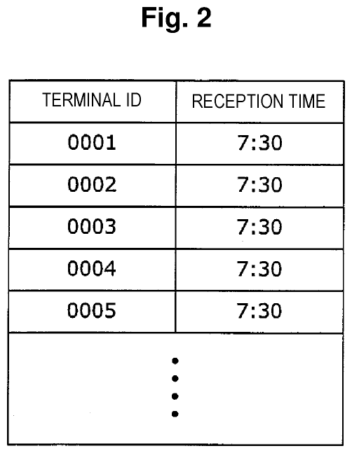

Main processing data stored in the storage unit 24 includes a detection list 24A. FIG. 2 illustrates an exemplary configuration of the detection list. In this example, the list records pairs of the terminal ID of a terminal 10 having detected vibration and a reception time at which the terminal ID wirelessly transmitted from the terminal 10 is received.

The program 24P is a program read from the storage unit 24 and executed by the CPU when the item management processing is performed at the management device 20. The program 24P is read from an external device or a recording medium (both not illustrated) connected with the management device 20 and is stored in the storage unit 24 in advance. The program 24P may be achieved by a software application executed on a smartphone or a tablet.

The terminal recording unit 25 has a function to sequentially record, in response to each reception of terminal-side vibration data wirelessly transmitted from a terminal 10 by the wireless I/F unit 21, a terminal ID received together with the terminal-side vibration data and a reception time at which the terminal ID is received to the detection list 24A in the storage unit 24.

The terminal management unit 26 has a function to display each terminal ID recorded in the detection list 24A on a screen at the display unit 23 in response to recording of terminal-side vibration data or in response to a user's collation instruction detected by the operation input unit 22.

### [Operation in First Embodiment]

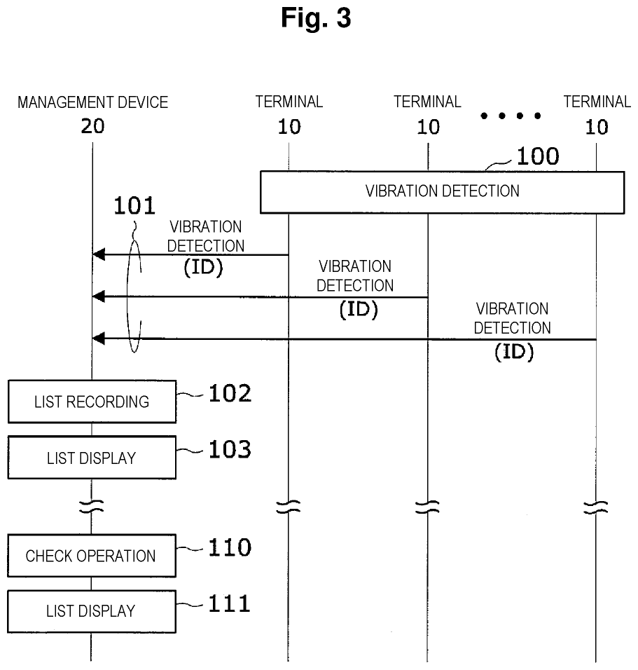

Subsequently, the operation of the item management system 1 according to the present embodiment will be described below with reference to FIG. 3. FIG. 3 is a sequence diagram illustrating an item management operation according to the first embodiment.

The following description will be made on an example in which, when a user having a bag in which a plurality of brought items are stored departs, these brought items are checked on a smartphone of the user. Assume that a terminal 10 is mounted on each brought item and a bag in advance, and an application configured to achieve functions of the management device 20 is installed on the smartphone.

When the user lifts the bag in which the plurality of brought items are stored, vibration is detected by the acceleration sensors 11 of the terminals 10 (step 100), and terminal-side vibration data representing the vibration detection and the terminal IDs of the terminals are wirelessly transmitted at once from the wireless circuits 13 of the terminals 10 (step 101).

In the management device 20, in response to reception of the terminal-side vibration data from each terminal 10 by the wireless I/F unit 21, the terminal recording unit 25 sequentially records the terminal ID received together with the terminal-side vibration data to the detection list 24A (step 102), and the terminal management unit 26 displays each terminal ID recorded in the detection list 24A on a screen at the display unit 23 (step 103).

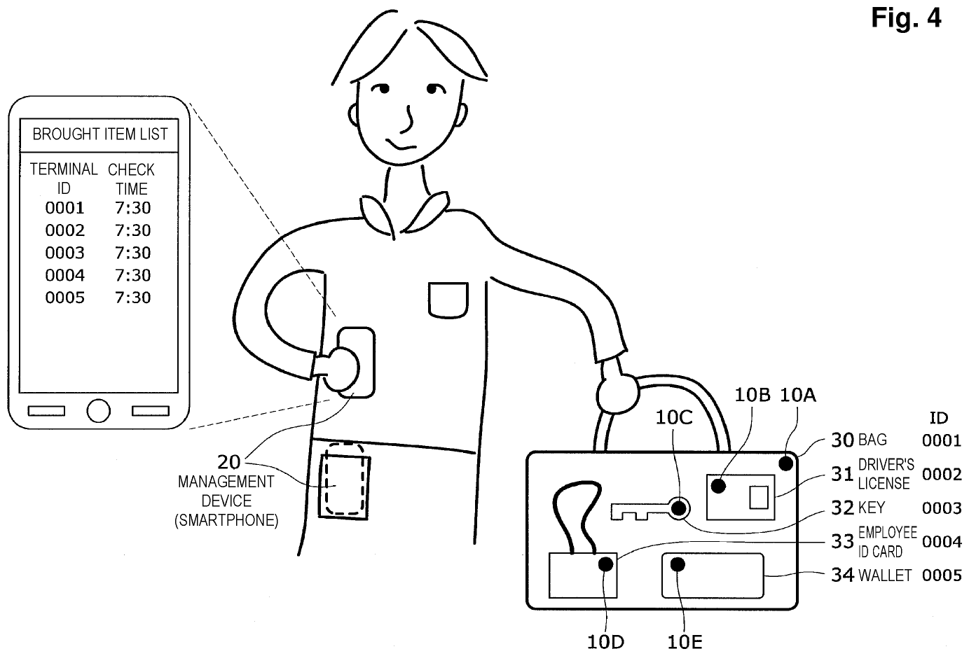

FIG. 4 illustrates exemplary brought-item notification operation at departure. In this example, an employee checks brought items when departing to a company in the morning. The brought items are a driver's license 31, a key 32, an employee ID card 33, and a wallet 34 in a bag 30. Terminals 10A, 10B, 10C, 10D, and 10E having terminal IDs of “0001”, “0002”, “0003”, “0004”, and “0005” are mounted on the bag 30, the driver's license 31, the key 32, the employee ID card 33, and the wallet 34, respectively.

In this case, when the user lifts the bag 30, the terminals 10A, 10B, 10C, 10D, and 10E of the bag 30, the driver's license 31, the key 32, the employee ID card 33, and the wallet 34 each detect vibration and wirelessly transmit terminal-side vibration data and the terminal ID of the terminal. A smartphone as the management device 20 records the terminal ID received together with the terminal-side vibration data from each of the terminals 10A, 10B, 10C, 10D, and 10E to the detection list 24A, and displays the terminal IDs as a brought item list on a screen.

Accordingly, the user can easily check that the driver's license 31, the key 32, the employee ID card 33, and the wallet 34 are in the bag 30 by referring to the brought item list displayed on the screen at the smartphone. Although only the terminal IDs are displayed on the screen, the user can check terminal IDs displayed on the screen at the smartphone by, for example, lifting each item to provide vibration to the item in advance, which then makes it extremely easy to associate each terminal ID with an item. This saves work of registering the correspondence relation between an item and the terminal ID of a terminal to a smartphone.

Thereafter, in the management device 20, when a user's check operation is detected by the operation input unit 22 (step 110), the terminal management unit 26 displays each terminal ID recorded in the detection list 24A in the storage unit 24 on a screen at the display unit 23 (step 111).

Accordingly, the user can check each terminal ID recorded in the detection list 24A on the screen and check each item in the bag 30 at an optional timing.

### [Effects of First Embodiment]

Accordingly, in the present embodiment, each terminal 10 is mounted in advance on an item as a management target, and when vibration of the item is detected by the acceleration sensor 11, the terminal 10 wirelessly transmits terminal-side vibration data representing the vibration detection and a terminal ID for identifying the terminal, and in response to reception of the terminal-side vibration data wirelessly transmitted from each terminal 10, the management device 20 sequentially records the terminal ID received together with the terminal-side vibration data to the detection list 24A in the storage unit 24 and displays the terminal IDs recorded in the detection list 24A on a screen.

Accordingly, the terminal ID of an item is displayed on a screen at the management device 20 when vibration is provided to the item. Thus, a user can check, for example, each brought item in a bag based on the terminal ID of the brought item. Moreover, the user can provide vibration to an item by, for example, lifting each item and check in advance a terminal ID displayed on a screen at the management device 20. This saves work of registering in advance the correspondence relation between an item and the terminal ID of a terminal 10 to the management device 20, and allows the user to manage the item with a light work load. Accordingly, a brought-item notification system can be achieved by the item management system 1.

The present embodiment describes above an example in which an employee checks brought items when departing to a company. The present embodiment is not limited thereto but is also applicable to, for example, a case in which a learner departing to a school checks brought items such as textbooks, notebooks, and writing materials and a case in which a worker departing to a job site checks brought items such as gears and tools.

### Second Embodiment

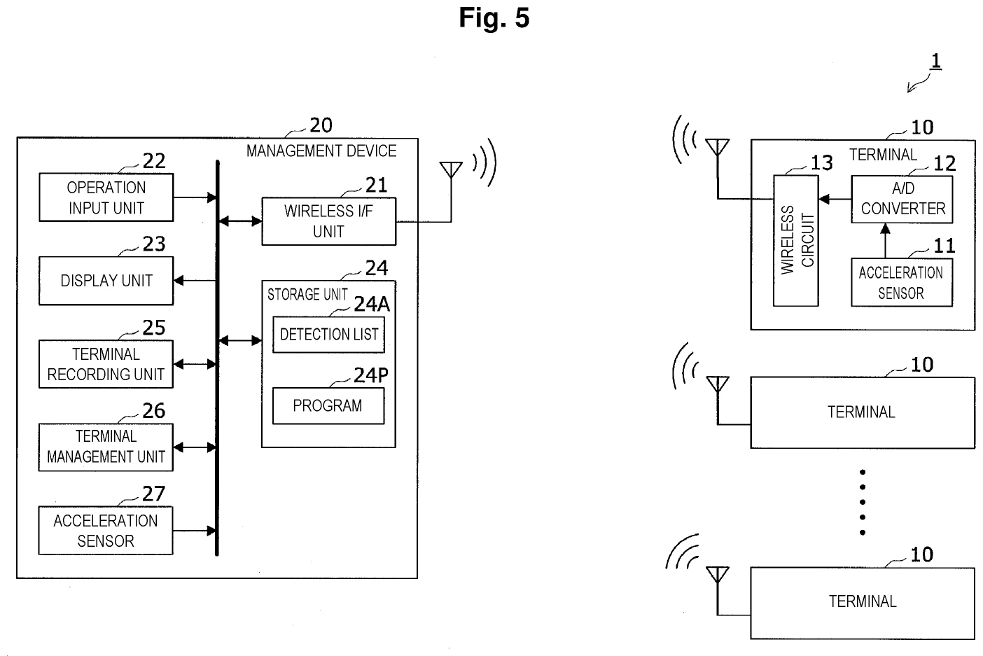

Subsequently, the item management system 1 according to a second embodiment of the present invention will be described below with reference to FIG. 5. FIG. 5 is a block diagram illustrating the configuration of the item management system according to the second embodiment.

The present embodiment describes a case in which the terminal ID of a terminal 10 is recorded to the detection list 24A when vibration of the terminal 10 and vibration of the management device 20 are simultaneously detected.

Specifically, in the present embodiment, the wireless circuit 13 of each terminal 10 has a function to detect vibration of an item on which the terminal 10 is mounted by performing threshold processing on acceleration data obtained by the acceleration sensor 11, and a function to wirelessly transmit terminal-side vibration data in a duration in which vibration is detected. The wireless circuit 13 may repeatedly wirelessly transmit the terminal ID as the terminal-side vibration data in a duration in which vibration is detected.

Alternatively, the wireless circuit 13 may wirelessly transmit the terminal ID as the terminal-side vibration data once when vibration is initially determined, and thereafter, may determine the existence of vibration at each elapse of, for example, a certain duration of 1 to 10 seconds approximately, which is set in advance and shorter than a duration in which the item is used, and may wirelessly transmit the terminal ID when having determined that vibration is present. In this case, the frequency of transmission of the terminal ID can be reduced, and thus electric power consumption at the terminal 10 can be reduced.

The management device 20 also includes an acceleration sensor (second acceleration sensor) 27 configured to detect vibration of the own device (management device 20) and output an acceleration signal.

The terminal recording unit 25 has a function to detect vibration of the own device (management device 20) by performing A/D conversion of the acceleration signal from the acceleration sensor 27 and performing threshold processing on obtained acceleration data, and a function to generate management-side vibration data in a duration in which vibration of the own device is detected.

In addition, the terminal recording unit 25 has a function to compare, when recording a terminal ID, a first detection duration in which vibration of the corresponding item is detected according to terminal-side vibration data DV from the corresponding terminal 10 and a second detection duration in which vibration of the own device is detected according to generated management-side vibration data DJ, and a function to determine, as a result of the comparison, whether recording of the terminal ID to the detection list 24A is permitted based on the length of an overlap duration in which the first and second detection durations overlap each other or the frequency of detection of the overlap duration and sequentially record the terminal ID to the detection list 24A in accordance with determination that the recording is permitted.

Other configurations of the item management system 1, each terminal 10, and the management device 20 according to the present embodiment are the same as those of the first embodiment, and description thereof is omitted.

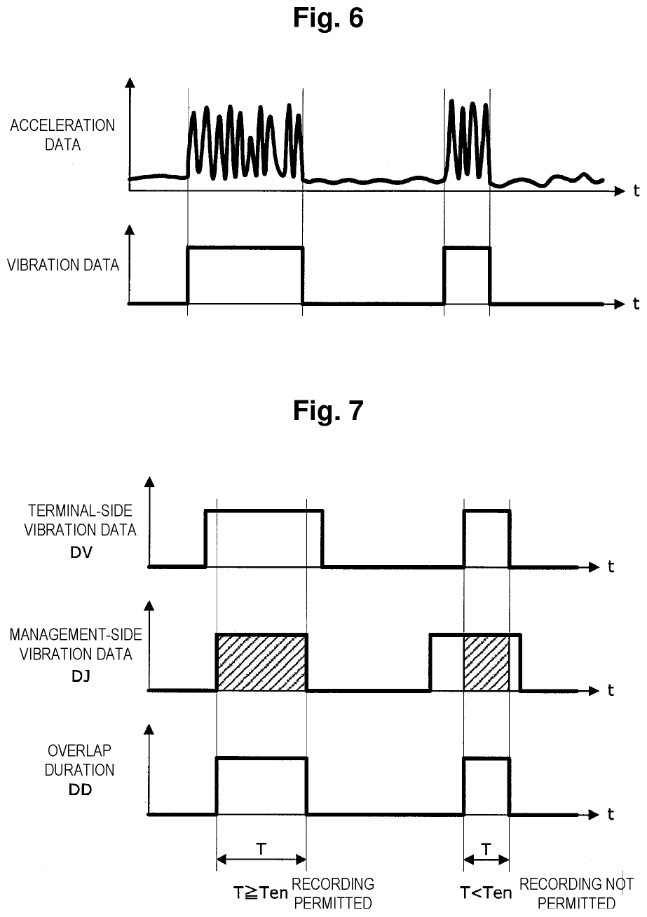

FIG. 6 is a signal waveform diagram illustrating the relation between acceleration data and vibration data. As illustrated in FIG. 6, the amplitude of the acceleration data (acceleration signal) largely changes with the strength of vibration. Thus, stable vibration data can be obtained by performing threshold processing at the wireless circuit 13 and the terminal recording unit 25. In the threshold processing, for example, comparison with two of high and low thresholds may be performed and both obtained outputs may be subjected to exclusive OR processing to generate vibration data. The threshold processing of the acceleration data of each terminal 10 may be performed at the terminal recording unit 25, which can lead to reduction of the number of circuit components and electric power consumption at the terminal 10.

FIG. 7 is a signal waveform diagram illustrating an exemplary comparison between the terminal-side and management-side vibration data. As illustrated in FIG. 7, the terminal recording unit 25 performs logic product processing of the terminal-side vibration data DV and the management-side vibration data DJ to specify an overlap duration DD in which the first and second detection durations overlap each other. It is determined that terminal ID recording to the detection list 24A is permitted when a time length T of the obtained overlap duration DD of continuous detection is equal to or longer than a determination duration Ten, or it is determined that terminal ID recording to the detection list 24A is not permitted when the time length T of the overlap duration DD is shorter than Ten.

According to the present embodiment, when the management device 20 does not vibrate simultaneously with a terminal 10, the terminal ID of the terminal 10 is not recorded to the detection list 24A. Accordingly, the number of times of terminal ID recording to the detection list 24A is reduced, and the number of recorded terminal IDs is reduced. Accordingly, the user can check, in the detection list 24A, only any terminal 10 vibrating simultaneously with a smartphone as the management device 20 and thus can easily recognize the detection list 24A displayed on a screen.

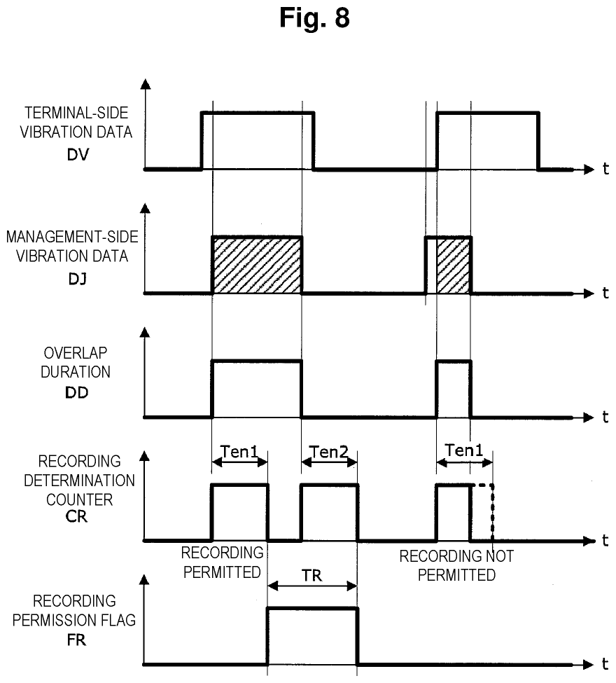

The time length T of the overlap duration DD may be determined by using a counter. FIG. 8 is a signal waveform diagram illustrating an exemplary comparison (counter) between the terminal-side and management-side vibration data. As illustrated in FIG. 8, a determination duration Ten1 may be measured by using a record determination counter CR configured to operate with a clock signal at a constant frequency. The terminal recording unit 25 activates the record determination counter CR in accordance with the start timing of the overlap duration DD, and determines that terminal ID recording is permitted when the overlap duration DD is continuously detected for a length equal to or longer than the determination duration Ten1 as the record determination counter CR counts up, or determines that terminal ID recording is not permitted when the overlap duration DD is shorter than the determination duration Ten1.

Alternatively, the terminal recording unit 25 may provide a record permission flag FR indicating whether terminal ID recording to the detection list 24A is permitted and check whether recording of a received terminal ID is permitted based on whether the record permission flag FR is in an “on” state indicating that the recording is permitted. In this case, the terminal recording unit 25 measures a determination duration Ten2 by the record determination counter CR, and when it is determined that the terminal ID recording is permitted as described above, the terminal recording unit 25 sets the record permission flag FR to the “on” state, starts count operation by the record determination counter CR at the end timing of the overlap duration DD, and sets the record permission flag FR to an “off” state when elapse of the determination duration Ten2 is checked as the record determination counter CR counts up.

Accordingly, a record permission duration TR is a duration until the determination duration Ten2 of a certain length elapses since it is checked that the overlap duration DD is continuously detected for a length equal to or longer than the determination duration Ten1. Thus, only when a terminal ID is received simultaneously with the overlap duration DD, the terminal ID is recorded to the detection list 24A, which achieves more stable terminal ID record processing.

The terminal management unit 26 may delete a terminal ID from the detection list 24A when a record expiration time set in advance has elapsed since recording of the terminal ID to the detection list 24A. Accordingly, a terminal ID recorded in the past is not displayed on a screen, which makes it easy for the user to recognize the detection list 24A displayed on the screen.

Although the above description is made on a case in which permission of terminal ID recording is determined based on the length of the overlap duration DD of the terminal-side vibration data DV and the management-side vibration data DJ, permission of terminal ID recording may be determined based on a detection frequency DN of the overlap duration DD in a constant detection time.

In this case, a determination frequency DNth may be set in advance, the detection frequency DN may be counted based on the start timing of the overlap duration DD, and it may be determined that terminal ID recording is permitted when the detection frequency DN becomes equal to or higher than the determination frequency DNth.

Accordingly, a terminal ID of a terminal 10 is recorded to the detection list 24A only after, for example, vibration is detected three times (DNth=3) simultaneously with the management device 20. Thus, the frequency of terminal ID recording to the detection list 24A is reduced, and the number of recorded terminal IDs is reduced. Accordingly, the user can easily recognize the detection list 24A displayed on a screen.

### Third Embodiment

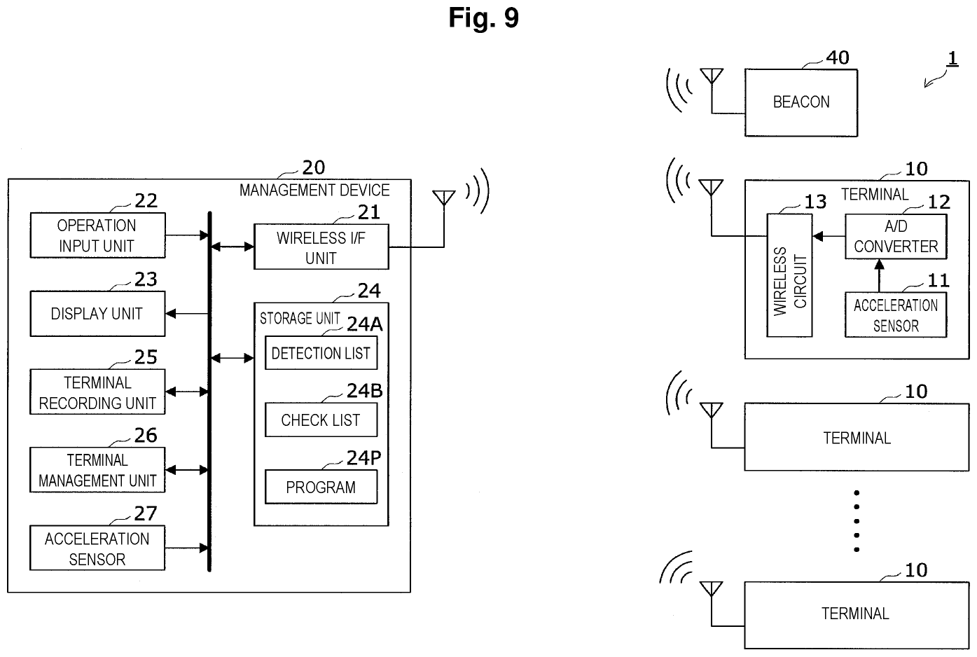

Subsequently, the item management system 1 according to a third embodiment of the present invention will be described below with reference to FIG. 9. FIG. 9 is a block diagram illustrating the configuration of the item management system according to the third embodiment.

The present embodiment describes a case in which the detection list 24A is displayed on a screen in response to a beacon signal from a beacon terminal 40 installed at a predetermined place.

Specifically, in the present embodiment, the terminal recording unit 25 of the management device 20 has a function to collate each terminal ID in the detection list 24A and each terminal ID in a check list 24B stored in the storage unit 24 when having received a beacon signal from the beacon terminal 40 installed at a predetermined place, and a function to give notification of an obtained collation result in a visible, audible, or vibrating manner through the display unit 23.

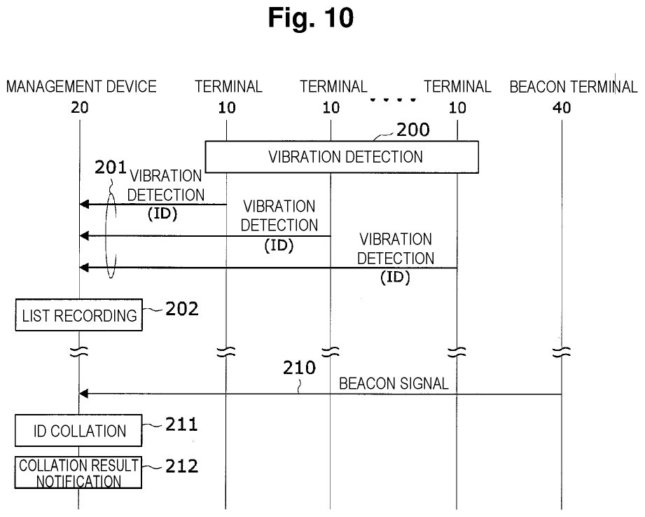

FIG. 10 is a sequence diagram illustrating an item management operation according to the third embodiment.

The following description with reference to FIG. 10 will be made on an example in which, when a user having a bag in which a plurality of brought items are stored departs, these brought items are checked on a smartphone of the user. Assume that a terminal 10 is mounted on each of the brought items and the bag in advance, and an application configured to achieve functions of the management device 20 is installed on the smartphone.

When the user lifts the bag in which the plurality of brought items are stored, vibration is detected by the acceleration sensors 11 of the terminals 10 (step 200), terminal-side vibration data representing the vibration detection and the terminal IDs of the terminals are wirelessly transmitted at once from the wireless circuits 13 of the terminals 10 (step 201).

In the management device 20, in response to reception of the terminal-side vibration data from each terminal 10 by the wireless I/F unit 21, the terminal recording unit 25 sequentially records the terminal ID received together with the terminal-side vibration data to the detection list 24A (step 202).

Thereafter, when the user has moved to a gateway, the management device 20 receives a beacon signal from the beacon terminal 40 (step 210). In response, the management device 20 collates each terminal ID in the detection list 24A in the storage unit 24 and each terminal ID in the check list 24B (step 211), and gives notification of an obtained collation result in a visible, audible, or vibrating manner (step 212).

Accordingly, each terminal ID recorded in the detection list 24A is automatically collated with each terminal ID in the check list 24B when the user has moved to a particular place such as a gateway.

Thus, according to the present embodiment, when any terminal ID in the check list 24B is not recorded in the detection list 24A, a brought item corresponding to the terminal ID is a forgotten item. Thus, when a collation result indicates that a terminal ID not recorded in the detection list 24A is found, an alert is emitted from the display unit 23 in a visible, audible, or vibrating manner so that the user can immediately recognize a forgotten item. Accordingly, a forgotten-item notification system can be achieved by the item management system 1.

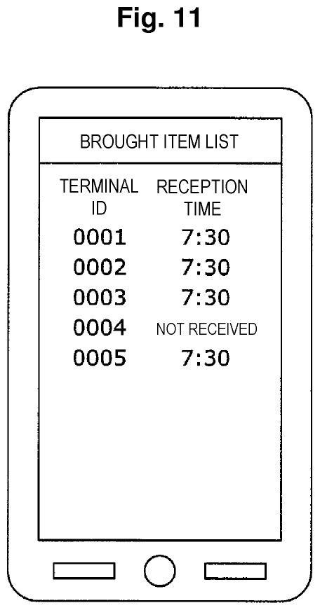

FIG. 11 illustrates an exemplary screen display of a brought item list. As illustrated in FIG. 11, on a screen at a smartphone as the management device 20, the terminal ID of a terminal 10 mounted on each brought item is displayed as the brought item list based on the check list 24B, and the reception time thereof on the detection list 24A is displayed in association with the terminal ID. When a terminal ID could not be received, “not received” is displayed as the reception time, which corresponds to a forgotten item.

When collating a terminal ID in the detection list 24A, the terminal recording unit 25 may search past detection lists stored in the storage unit 24 for a detection list corresponding to the date and time or day of week of the detection list 24A of the current day and may select the detection list as the check list 24B.

Accordingly, for example, the detection list 24A of the previous day can be selected as the check list 24B, which can reduce a work load required for setting of the check list 24B.

When the detection list 24A of the previous day is selected as the check list 24B, brought items of the current day are collated with those of the previous day, and thus it is possible to easily check a brought item that is brought on the previous day but not brought on the current day, in other words, a forgotten item. Accordingly, for example, an employee departing to a company can check brought items such as a wallet and an employee ID card, or a worker departing to a job site can check brought items such as gears and tools.

When the detection list 24A of the previous week is selected as the check list 24B, brought items of the current day are collated with those of the previous week, and thus it is possible to easily check a brought item that was brought in the previous week but not brought on the current day, in other words, a forgotten item. Accordingly, for example, a child departing to a lesson on a particular day of the week can check brought items used in the lesson.

### Fourth Embodiment

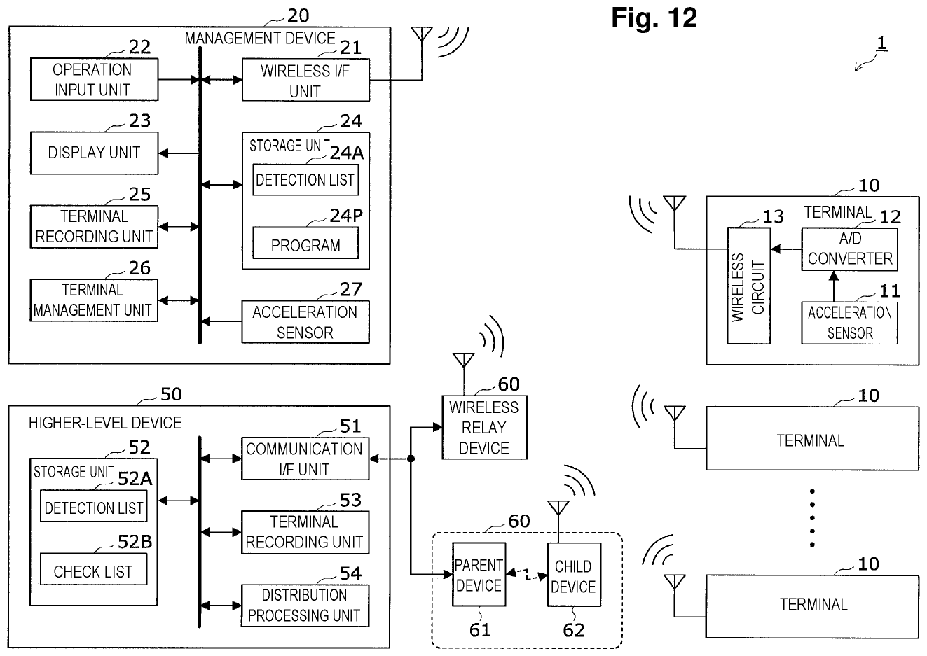

Subsequently, the item management system 1 according to a fourth embodiment of the present invention will be described below with reference to FIG. 12. FIG. 12 is a block diagram illustrating the configuration of the item management system according to the fourth embodiment.

In the present embodiment, a higher-level device 50 is provided separately from the management device 20, records a terminal ID from terminal 10 to a detection list 52A, and provides information related to a terminal 10 mounted on an item by distributing the detection list 52A to the management device 20.

Specifically, the higher-level device 50 according to the present embodiment has a function to sequentially record, in response to reception of terminal-side vibration data wirelessly transmitted from each terminal 10, a terminal ID received together with the terminal-side vibration data to the detection list 52A in a storage unit 52, and a function to provide information of the detection list 52A to the management device 20 through a wireless line.

The management device 20 has a function to display, on a screen, each terminal ID recorded in the detection list 52A as information provided from the higher-level device 50 through a communication line.

### [Higher-Level Device]

Subsequently, the configuration of the higher-level device 50 according to the present embodiment will be described below in detail with reference to FIG. 12.

The higher-level device 50 is mainly achieved by an information processing device such as a server device and includes, as main functional components, a communication I/F unit 51, a storage unit 52, a terminal recording unit 53, and a distribution processing unit 54, and these functional components are connected with each other to perform data forwarding through an internal bus. Among these functional components, the terminal recording unit 53 and the distribution processing unit 54 are achieved through cooperation of a CPU with a program (both not illustrated).

The communication I/F unit 51 has a function to perform data communication with the terminals 10 through a wireless relay device 60 based on a short-distance wireless communication standard such as BLE, and a function to perform data communication with the management device 20 through the wireless relay device 60 based on a short-distance wireless communication standard such as BLE or based on a wireless communication standard such as Wi-Fi (recorded trademark).

The storage unit 52 is achieved by a storage device such as a hard disk or a semiconductor memory and has a function to store processing data and programs used for the item management processing at the higher-level device 50.

Main processing data stored in the storage unit 52 includes the detection list 52A. As in the detection list 24A in FIG. 2 described above, the detection list 52A records pairs of the terminal ID of a terminal 10 having detected vibration and a reception time at which the terminal ID wirelessly transmitted from the terminal 10 is received.

The terminal recording unit 53 has a function to compare a first detection duration in which vibration of an item is detected according to terminal-side vibration data wirelessly transmitted from the corresponding terminal 10 and a second detection duration in which vibration of the management device 20 is detected according to management-side vibration data wirelessly transmitted from the management device 20, both received by the communication I/F unit 51 through the wireless relay device 60, determine whether recording of the corresponding terminal ID to the detection list 52A is permitted based on the length of an overlap duration in which the first and second detection durations overlap each other or the frequency of detection of the overlap duration, and sequentially record the terminal ID to the detection list 52A in accordance with determination that the recording is permitted.

As in the terminal recording unit 25 described in the first embodiment, in response to reception of terminal-side vibration data wirelessly transmitted from each terminal 10, the terminal recording unit 53 may sequentially record a terminal ID received together with the terminal-side vibration data to the detection list 52A in the storage unit 52 without using management-side vibration data.

The distribution processing unit 54 has a function to provide information by distributing the detection list 52A in the storage unit 52 to the management device 20 through the communication I/F unit 51 in response to a distribution request from the management device 20, a function to collate each terminal ID in the detection list 52A in the storage unit 52 and each terminal ID in a check list 52B stored in the storage unit 52 in response to a collation request from the management device 20 and provide information by distributing an obtained collation result to the management device 20, and a function to, when collating the terminal IDs in the detection list 52A, search past detection lists stored in the storage unit 52 for a detection list corresponding to the date and time or day of week of the detection list 52A of the current day and generate the check list 52B from any terminal ID, the record rate of which is a probability equal to or higher than a predetermined value among terminal IDs recorded in the obtained detection list.

The wireless relay device 60 includes a function to accommodate the terminals 10 and the management device 20 through wireless lines and relay-connect the terminals 10 and the management device 20 to the higher-level device 50, a function to measure a standard time synchronized with a time management server by accessing the time management server (not illustrated) through a communication network, and a function to, when relay-forwarding terminal IDs wirelessly transmitted from the terminals 10 to the higher-level device 50, notify the higher-level device 50 of the standard time at the relay-forwarding as the reception times of the terminal IDs. Accordingly, the area of accommodation of the terminals 10 and the management device 20 can be significantly increased without degrading the accuracy of the reception times.

The wireless relay device 60 may include a parent device 61 and a child device 62 connected with each other through a wireless relay line. In this case, the child device 62 has a function to accommodate each of the terminals 10 and the management device 20, and relay-connect each of the terminals 10 and the management device 20 to the parent device 61 through the wireless relay line. The parent device 61 has a function to relay-connect, to the higher-level device 50, each of the terminals 10 and the management device 20 relay-connected through the child device 62 and when notifying the higher-level device 50 of reception times, correct the reception times based on a delay time through the wireless relay line, which is obtained through measurement in advance, and then notify the higher-level device 50 of the corrected reception times. Accordingly, the area of accommodation of the terminals 10 and the management device 20 can be significantly increased without degrading the accuracy of the reception times.

### [Operation in Fourth Embodiment]

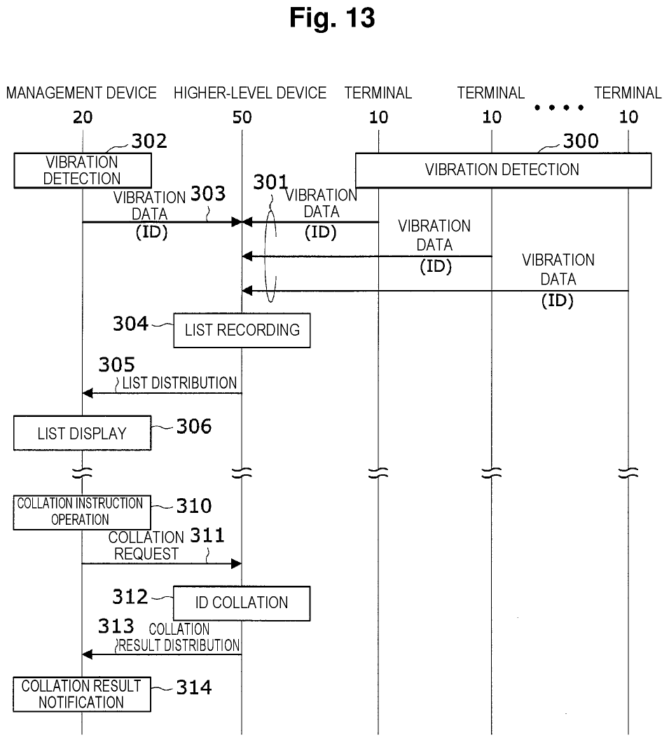

Subsequently, the operation of the item management system 1 according to the present embodiment will be described below with reference to FIG. 13. FIG. 13 is a sequence diagram illustrating an item management operation according to the fourth embodiment.

The following description will be made on an example in which, when a user having a bag in which a plurality of brought items are stored departs, these brought items are checked on a smartphone of the user. Assume that a terminal 10 is mounted on each of the brought items and the bag in advance, and an application configured to achieve functions of the management device 20 is installed on the smartphone.

When the user lifts the bag in which the plurality of brought items are stored, vibration of the brought items is detected by the acceleration sensors 11 of the terminals 10 (step 300), and terminal-side vibration data representing the vibration detection and the terminal IDs of the terminals are wirelessly transmitted at once from the wireless circuits 13 of the terminals 10 (step 301). Similarly, in the management device 20, vibration of the management device 20 is detected by the acceleration sensor 27 (step 302), and management-side vibration data representing the vibration detection is wirelessly transmitted from the wireless I/F unit 21 of the management device 20 (step 303).

The higher-level device 50 receives the terminal-side vibration data from each terminal 10 and the management-side vibration data from the management device 20 through the wireless relay device 60 by the communication I/F unit 51, and compares a first detection duration in which vibration of the corresponding item is detected according to the terminal-side vibration data and a second detection duration in which vibration of the management device 20 is detected according to the management-side vibration data.

As a result of the comparison, whether terminal ID recording to the detection list 52A is permitted is determined based on the length of an overlap duration in which the first and second detection durations overlap each other or the frequency of detection of the overlap duration, and the terminal ID is sequentially recorded to the detection list 52A in accordance with determination that the recording is permitted (step 304).

The generation of vibration data from acceleration data (acceleration signal) and the threshold processing at the terminals 10 and the management device 20 are the same as those in FIG. 6 described above. The threshold processing of the acceleration data of the terminals 10 and the management device 20 may be performed at the terminal recording unit 53, which can lead to reduction of the number of circuit components and electric power consumption at the terminals 10 and the management device 20.

The comparison of the terminal-side and management-side vibration data and the recording permission determination at the terminal recording unit 53 are the same as those in FIGS. 7 and 8 described above.

After the terminal ID recording, the distribution processing unit 54 acquires the detection list 52A from the storage unit 52 and distributes the detection list 52A from the communication I/F unit 51 to the management device 20 through the wireless relay device 60 (step 305).

The terminal management unit 26 of the management device 20 receives the detection list 52A from the higher-level device 50 through the wireless I/F unit 21 and displays each terminal ID recorded in the detection list 52A on a screen at the display unit 23 (step 306).

In response to a user's collation instruction detected by the operation input unit 22 (step 310), the terminal management unit 26 of the management device 20 wirelessly transmits a collation request related to the detection list 52A to the higher-level device 50 through the wireless I/F unit 21 (step 311). The beacon terminal 40 as illustrated in FIG. 9 may be installed at a predetermined place such as a gateway, and the terminal management unit 26 may wirelessly transmit the collation request when a beacon signal from the beacon terminal 40 is received by the management device 20 as illustrated in FIG. 10. Accordingly, ID collation can be automatically performed when the user has moved to a particular place.

In response to the collation request from the management device 20, which is received by the communication I/F unit 51 through the wireless relay device 60, the distribution processing unit 54 of the higher-level device 50 collates each terminal ID in the detection list 52A and each terminal ID in the check list 52B stored in the storage unit 52 (step 312), and distributes an obtained collation result to the management device 20 (step 313).

The terminal management unit 26 of the management device 20 receives the collation result from the higher-level device 50 and gives notification of the collation result in a visible, audible, or vibrating manner (step 314).

Accordingly, as described above, each of the terminal IDs transmitted from the terminals 10 of the brought items upon vibration at departure and recorded in the detection list 52A is collated with each terminal ID in the check list 52B in response to the collation request from the management device 20.

Accordingly, when a terminal ID in the check list 52B is not recorded in the detection list 52A, a brought item corresponding to the terminal ID is a forgotten item. Thus, when a collation result indicates that a terminal ID not recorded in the detection list 52A is found, an alert is emitted from the display unit 23 of the management device 20 in a visible, audible, or vibrating manner so that the user can immediately recognize a forgotten item. Accordingly, a lost-property notification system can be achieved by the item management system 1.

When collating a terminal ID in the detection list 52A, the distribution processing unit 54 of the higher-level device 50 may search past detection lists stored in the storage unit 52 for a detection list corresponding to the date and time or day of week of the detection list 52A of the current day and may select the detection list as the check list 52B.

Accordingly, for example, the detection list 52A of the previous day can be selected as the check list 52B of the current day, which can reduce a work load required for setting of the check list 52B.

According to the present embodiment, when the management device 20 does not vibrate simultaneously with a terminal 10 in a case in which management-side vibration data is used, terminal IDs from the terminal 10 are not recorded to the detection list 52A. Thus, the frequency of terminal ID recording to the detection list 52A is reduced, and the number of recorded terminal IDs is reduced. Accordingly, the user can check, in the detection list 52A, only any terminal 10 vibrating simultaneously with a smartphone as the management device 20, and can easily recognize the detection list 52A displayed on a screen.

In addition, according to the present embodiment, the detection list 52A is collated with the check list 52B, and thus, when a terminal ID in the check list 52B is not recorded in the detection list 52A, a brought item corresponding to the terminal ID is a forgotten item. Thus, when a collation result indicates that a terminal ID not recorded in the detection list 52A is found, an alert is emitted from the display unit 23 of the management device 20 in a visible, audible, or vibrating manner so that the user can immediately recognize a forgotten item. Accordingly, a lost-property notification system can be achieved by the item management system 1.

When collating a terminal ID in the detection list 52A, the terminal recording unit 53 may search past detection lists stored in the storage unit 52 for a detection list corresponding to the date and time or day of week of the detection list 52A of the current day and may select the detection list as the check list 52B.

Accordingly, for example, the detection list 52A of the previous day can be selected as the check list 52B of the current day, which can reduce a work load required for setting of the check list 52B.

When the detection list 52A of the previous day is selected as the check list 52B, brought items of the current day are collated with those of the previous day, and thus it is possible to easily check a brought item that is brought on the previous day but not brought the current day, in other words, a forgotten item. Accordingly, an employee departing to a company can check brought items such as a wallet and an employee ID card, or a worker departing to a job site can check brought items such as gears and tools.

When the detection list 52A of the previous week is selected as the check list 52B, brought items of the current day are collated with those of the previous week, and thus it is possible to easily check a brought item that is brought in the previous week but not brought on the current day, in other words, a forgotten item. Accordingly, when departing to a lesson on a particular day of the week, a learner can check brought items used in the lesson.

### [Extension of Embodiments]

The present invention is described above with reference to embodiments but not limited to the above-described embodiments. Configurations and specifications of the present invention may be provided with various changes that could be understood by the skilled person in the art within the scope of the present invention. In addition, the embodiments may be optionally combined without inconsistency.

### REFERENCE SIGNS LIST

1 item management system
10, 10A, 10B, 10C, 10D, 10E terminal
11 acceleration sensor
12 A/D converter
13 wireless circuit
20 management device
21 wireless I/F unit
22 operation input unit
23 display unit
24 storage unit
24A detection list
24B check list
24P program
25 terminal recording unit
26 terminal management unit
27 acceleration sensor
30 bag
31 driver's license
32 key
33 employee ID card
34 wallet
40 beacon terminal
50 higher-level device
51 communication I/F unit
52 storage unit
52A detection list
52B check list
53 terminal recording unit
54 distribution processing unit
60 wireless relay device
61 parent device
62 child device

1.-14. (canceled)

15. An item management system comprising:
at least one terminal on an item as a management target, each terminal configured to wirelessly transmit a terminal ID for identifying the terminal when vibration is detected by a built-in first acceleration sensor of the terminal; and
a management device configured to:
sequentially record the terminal ID received from each of the at least one terminal to a detection list in a storage unit; and
display the terminal ID recorded in the detection list on a screen.

16. The item management system according to claim 15, wherein:
the at least one terminal is configured to wirelessly transmit terminal-side vibration data in a duration in which the vibration is detected; and
the management device is configured to generate management-side vibration data in a duration in which vibration is detected by a built-in second acceleration sensor, and when recording each terminal ID, the management device is configured to compare a first detection duration in which vibration of the item is detected according to the terminal-side vibration data and a second detection duration in which vibration of the management device is detected according to the management-side vibration data, and determine whether recording of the terminal ID to the detection list is permitted based on a length of an overlap duration in which the first and the second detection durations overlap each other or a frequency of detection of the overlap duration.

17. The item management system according to claim 16, wherein the management device is configured to record each terminal ID to the detection list only when the terminal ID is received until a record permission duration of a certain length elapses from a check that the length of the overlap duration has reached a determination duration set in advance.

18. The item management system according to claim 15, wherein, when a collation instruction is input through an operation or when a beacon signal is received from a beacon terminal installed at a predetermined place, the management device is configured to collate each terminal ID in the detection list and each terminal ID in a check list stored in the storage unit and give notification of an obtained collation result in a visible, audible, or vibrating manner.

19. The item management system according to claim 18, wherein, when collating each terminal ID in the detection list, the management device is configured to search past detection lists stored in the storage unit for a corresponding detection list corresponding to a date and time or day of week of the detection list and select the corresponding detection list as the check list.

20. The item management system according to claim 15, wherein, when recording each terminal ID, the management device is configured to record, in addition to the terminal ID, a reception time at which the terminal ID is received to the detection list, and when displaying each terminal ID recorded in the detection list on a screen, the management device displays the reception time together with the terminal ID on the screen.

21. An item management system comprising:
at least one terminal on an item as a management target, each terminal configured to wirelessly transmit a terminal ID for identifying the terminal when vibration is detected by a built-in first acceleration sensor of the terminal;
a higher-level device configured to sequentially record the terminal ID received from each of the at least one terminal to a detection list in a storage unit; and
a management device configured to display, on a screen, the terminal ID recorded in the detection list acquired from the higher-level device through a communication line.

22. The item management system according to claim 21, wherein:
the at least one terminal is configured to wirelessly transmit terminal-side vibration data in a duration in which the vibration is detected;
the management device is configured to wirelessly transmit management-side vibration data in a duration in which vibration of the management device is detected by a second acceleration sensor; and
when recording each terminal ID, the higher-level device is configured to compare a first detection duration in which vibration of the item is detected according to the terminal-side vibration data and a second detection duration in which vibration of the management device is detected by the terminal-side vibration data, and determine whether recording of the terminal ID to the detection list is permitted based on a length of an overlap duration in which the first and the second detection durations overlap each other or a frequency of detection of the overlap duration.

23. The item management system according to claim 21, wherein:
the management device is configured to wirelessly transmit a collation request related to the detection list to the higher-level device in accordance with a collation instruction input through an operation and give notification of a collation result as information provided from the higher-level device in response to the collation request in a visible, audible, or vibrating manner; and
the higher-level device is configured to collate each terminal ID in the detection list and each terminal ID in a check list stored in the storage unit in response to the collation request from the management device and provide information of an obtained collation result to the management device, and when collating each terminal ID in the detection list, the higher-level device is configured to search past detection lists stored in the storage unit for a detection list corresponding to a date and time or day of week of the detection list and generate the check list from any terminal ID, a record rate of which is a probability equal to or higher than a predetermined value among terminal IDs recorded in the obtained detection list.

24. The item management system according to claim 21, wherein:
when recording each terminal ID, the higher-level device is configured to record, in addition to the terminal ID, a reception time at which the terminal ID is received to the detection list; and
when displaying each terminal ID recorded in the detection list on a screen, the management device is configured to display the reception time together with the terminal ID on the screen.

25. The item management system according to claim 24, further comprising a wireless relay device configured to accommodate the at least one terminal and the management device through wireless lines and relay-connect the at least one terminal and the management device to the higher-level device, wherein:
the wireless relay device is configured to measure a standard time synchronized with a time management server, and when relay-forwarding the terminal ID wirelessly transmitted from each of the at least one terminal to the higher-level device, the wireless relay device is configured to notify the higher-level device of the standard time at the relay-forwarding as the reception time of the terminal ID; and
when recording each terminal ID, the higher-level device is configured to record the reception time of the terminal ID notified by the wireless relay device to the detection list in addition to the terminal ID.

26. The item management system according to claim 25, wherein:
the wireless relay device includes a parent device and a child device connected with each other through a wireless relay line;
the child device is configured to accommodate the at least one terminal or the management device and relay-connect the at least one terminal or the management device to the parent device through the wireless lines; and
the parent device is configured to relay-connect, to the higher-level device, the at least one terminal or the management device relay-connected through the child device, and when notifying the higher-level device of the reception time, the parent device is configured to correct the reception time based on a delay time through the wireless relay line, which is obtained through measurement in advance, and then notify the higher-level device of the corrected reception time.

27. An item management method comprising:
a step in which at least one terminal mounted in advance on an item as a management target wirelessly transmits a terminal ID for identifying the terminal when vibration is detected by a built-in first acceleration sensor; and
a step in which a management device sequentially records the terminal ID received from each of the at least one terminal to a detection list in a storage unit and displays the terminal ID recorded in the detection list on a screen.

28. The item management method according to claim 27, wherein:
the at least one terminal wirelessly transmits terminal-side vibration data in a duration in which the vibration is detected; and
the management device generates management-side vibration data in a duration in which vibration is detected by a built-in second acceleration sensor, and when recording each terminal ID, the management device compares a first detection duration in which vibration of the item is detected according to the terminal-side vibration data and a second detection duration in which vibration of the management device is detected according to the management-side vibration data, and determines whether recording of the terminal ID to the detection list is permitted based on a length of an overlap duration in which the first and the second detection durations overlap each other or a frequency of detection of the overlap duration.

29. The item management method according to claim 28, wherein the management device records each terminal ID to the detection list only when the terminal ID is received until a record permission duration of a certain length elapses from a check that the length of the overlap duration has reached a determination duration set in advance.

30. The item management method according to claim 27, wherein, when a collation instruction is input through an operation or when a beacon signal is received from a beacon terminal installed at a predetermined place, the management device collates each terminal ID in the detection list and each terminal ID in a check list stored in the storage unit and gives notification of an obtained collation result in a visible, audible, or vibrating manner.

31. The item management method according to claim 30, wherein, when collating each terminal ID in the detection list, the management device searches past detection lists stored in the storage unit for a corresponding detection list corresponding to a date and time or day of week of the detection list and selects the corresponding detection list as the check list.

32. The item management method according to claim 27, wherein, when recording each terminal ID, the management device records, in addition to the terminal ID, a reception time at which the terminal ID is received to the detection list, and when displaying each terminal ID recorded in the detection list on a screen, the management device displays the reception time together with the terminal ID on the screen.
